(19) United States
(12) Patent Application Publication
(10) Pub. No.: US 2010/0110032 A1
(43) Pub. Date: May 6, 2010

(54) INTERFACE APPARATUS FOR GENERATING CONTROL COMMAND BY TOUCH AND MOTION, INTERFACE SYSTEM INCLUDING THE INTERFACE APPARATUS, AND INTERFACE METHOD USING THE SAME

(75) Inventors: Ki-yong KIM, Seoul (KR); Seong-il CHO, Seoul (KR); Jung-min KANG, Seoul (KR); Young-kwang SEO, Seoul (KR); Ki-jun JEONG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/605,665

(22) Filed: Oct. 26, 2009

(30) Foreign Application Priority Data
Oct. 30, 2008 (KR) 10-2008-0107096

(51) Int. Cl. G06F 3/041

(52) U.S. Cl. 345/173

(57) ABSTRACT

An interface apparatus for generating a control command by touch and motion, interface system, and interface method using the same is provided. The interface apparatus includes a touch screen, motion sensor, and control unit for generating a control command. Accordingly, a user can manipulate a GUI more easily and conveniently.

### CROSS-REFERENCE TO RELATED APPLICATIONS

This application claims priority under 35 U.S.C. §119 from Korean Patent Application No. 10-2008-0107096, filed on Oct. 30, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to an interface apparatus, an interface system, and an interface method using the same, and more particularly, to an interface apparatus for generating a control command by touch and motion, an interface system including the apparatus, and an interface method using the same.

2. Description of the Related Art

As various functions have been added to electronic devices in recent days, most electronic devices receive commands from a user via a Graphic User Interface (GUI). Recently, as electronic devices have become increasingly multi-functional, GUIs have become more complicated, and accordingly the manipulation of an interface apparatus for controlling a GUI has also become more complicated.

In order to use such multi-functional electronic devices, a user must put up with the inconvenience of searching menus using a complicated GUI, and also must manipulate a complicated interface apparatus to handle the GUI.

Therefore, there is a need for methods for a user to use a GUI more easily and conveniently.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

In order to resolve above issues, the present invention provides an interface apparatus, an interface system, and an interface method which allow a user to use a GUI more easily, conveniently, and intuitively.

According to an exemplary aspect of the present invention, the interface apparatus comprises a touch screen which senses touch, a motion sensor which senses motion in a 3-dimensional space and a control unit which generates at least one of a first control command based on the touch, a second control command based on the motion, and a third control command based on interlocked manipulation of the touch and motion.

The control unit extract may extract at least one information from among the 2-dimensional coordinate information of the touch, the 3-dimensional coordinate information of the motion, and the configuration information of the motion, and generate at least one control command from among the first to third control command using the extracted information.

The first to third control commands may control at least one apparatus from among the interface apparatus and the external apparatus connected to the interface apparatus.

The control unit may transmit at least one control command from among the first to third control commands to at least one of the touch screen and the external apparatus based on at least one control command from among the first to third control commands.

The control unit may change a screen displayed on the touch screen based on at least one control command from among the first to third control commands.

The third control command may be a separate control command which is different from a combination of the first and second control commands.

The touch screen or the 3-dimensional space may be divided into a plurality of portions, and control unit may generate a different control command depending on the portion of the screen on which touch, the motion, or a combination of the touch and motion is sensed.

The plurality of portions may include a first portion to control the external apparatus connected to the interface apparatus and a second portion to control the touch screen.

The control unit may generate a first control command regarding the device based on the shape or location of the device which contacts the touch screen.

The first control command regarding the device may include at least one control command from among a command to display information regarding the device, a command to display contents stored in the device, a command to reproduce contents stored in the device, a command to transmit contents stored in the device, and a command to receive contents in the device.

The device may include a device having means for identifying the device and the control unit may generate a control command regarding the device based on the information regarding the device extracted from the identifying means.

The touch may include multi-touch, in which a plurality of portions of the touch screen are touched, and the motion may include multi-motion regarding a plurality of objects.

An interface method using at least one of a touch screen and a motion sensor comprises sensing touch, sensing motion in 3-dimensional space, and generating at least one control command from among a first control command based on the touch, a second control command based on the motion, and a third control command based on interlocked manipulation of the touch and motion.

The generating may comprise extracting at least one piece of information from among the 2-dimensional coordinate information of the touch, the 3-dimensional coordinate information of the motion, the configuration information of the motion, and generating at least one control command from among the first to third control commands using the extracted information.

The first to third control commands may control at least one of the touch screen and the external apparatus.

The interface method may further comprise transmitting at least one of the first to third control commands to at least one of the touch screen and the external apparatus based on at least one of the first to third control commands.

The interface method may further comprise changing a screen displayed on the touch screen based on at least one of the generated first to third control commands.

The third control command may be a separate control command different from a combination of the first to second command.

The touch screen or the 3-dimensional portion may be divided into a plurality of portions, and the generating may comprise generating a different control command depending on the portion of the screen on which touch, the motion, or the combination of the touch and motion is sensed.

The plurality of portions may include a first portion to control an external apparatus and a second portion to control the touch screen.

The generating may comprise generating a first control command regarding the device based on at least one of the shape and location of the device which contacts the touch screen.

The first control command regarding the device may include at least one of a command to display information regarding the device, a command to reproduce contents stored in the device, a command to transmit contents stored in the device, and a command to receive contents in the device.

The device may include a device having means for identifying the device, and the generating may comprise generating a first control command regarding the device based on information regarding the device extracted from the identifying means.

The touch may include a multi-touch, in which a plurality of portions of the touch screen are touched, and the motion may include a multi-motion regarding a plurality of objects.

An interface system comprises an interface apparatus which generates a control command based on input touch or sensed 3-dimensional motion and transmits the control command to the outside and at least one interlocking apparatus which receives the control command and is operated based on the received control command.

At least one of the interlocking apparatus may include at least one of the interface apparatus, image outputting apparatus, sound outputting apparatus, printing apparatus, and host apparatus.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is schematic view of an interface system to which the present invention is applicable;

FIG. 2 is a schematic view illustrating the structure of an interface apparatus according to an exemplary embodiment of the present invention;

FIG. 3 is a schematic view illustrating a user inputting a command by touch;

FIG. 4 is a schematic view provided to explain how to generate a control command using the touch input by a user;

FIG. 5 is a schematic view illustrating how a user's motion is sensed;

FIG. 6 is a schematic view provided to explain how to generate a control command using the sensed motion;

FIG. 7 and FIG. 8 are schematic views provided to explain how to generate a control command using the combination of touch and motion;

FIG. 9 to FIG. 11 are schematic views provided to explain how to generate a control command using a predetermined method;

FIG. 12 and FIG. 13 are schematic views provided to explain the concept of dragging by touch;

FIG. 14 and FIG. 15 are schematic views provided to explain the concept of dragging by motion;

FIG. 16 and FIG. 17 are schematic views provided to explain the concepts of multi-touch and multi-motion;

FIG. 18 and FIG. 19 are schematic views provided to explain the concept of interlocked manipulation;

FIG. 20 is a schematic view provided to explain the concept of interface manipulation for each section;

FIG. 21 to FIG. 23 are schematic views provided to explain the concept of interface manipulation for divided sections;

FIG. 24 to FIG. 26 are schematic views provided to explain the concept of interface manipulation by touching a device;

FIG. 27 is a schematic view provided to explain the concept of manipulation of an interface for connecting two monitors;

FIG. 28 and FIG. 29 are schematic views provided to explain the concept of another interface manipulation by touch by a device;

FIG. 30 and FIG. 31 are schematic views displaying each menu item by touching multi-devices using two devices;

FIG. 32 is a flow chart provided to explain the interface method according to the exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, the same drawing reference numerals are used for the same elements even in different drawings. The matters defined in the description, such as the detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

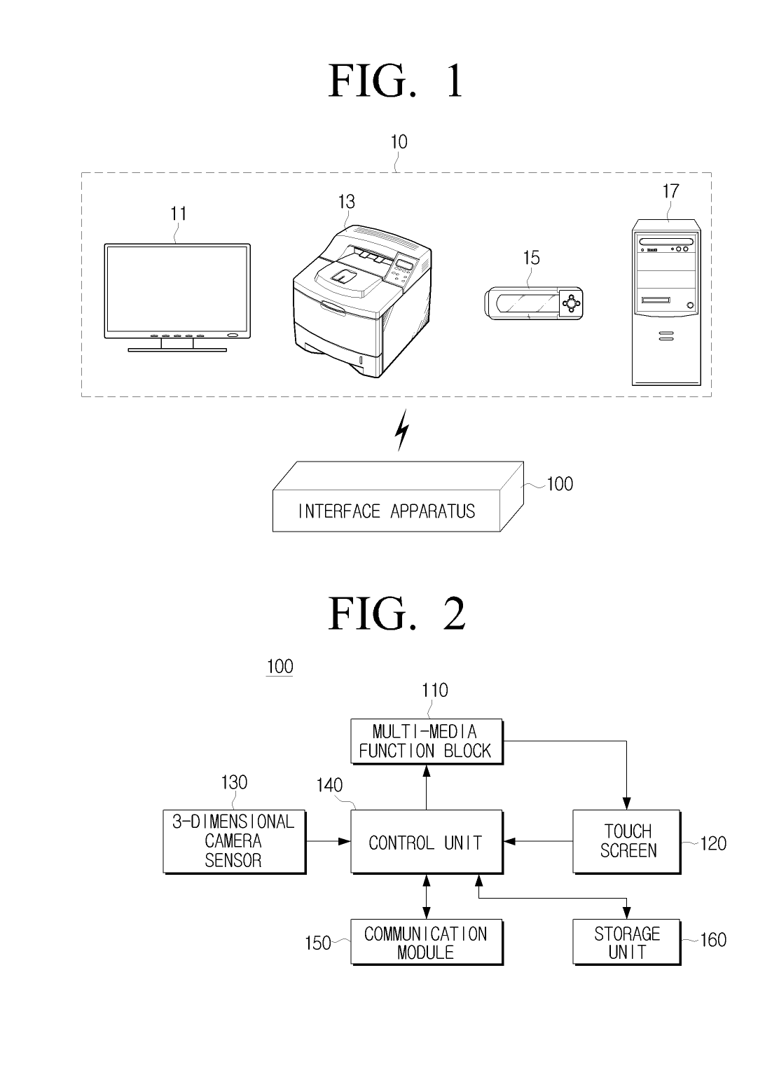

FIG. 1 is schematic view of an interface system to which the present invention is applicable. As illustrated in FIG. 1, the interface system comprises an interface apparatus 100 and an interlocking apparatus 10 which is used in association with the interface apparatus 100.

The interface apparatus 100 receives touch by a user, or senses motion by a user, and generates a control command based on the input touch or sensed motion. The interface apparatus 100 operates according to the control command generated based on the input touch or sensed motion.

More specifically, the interface apparatus 100 generates a control command to control the screen, a control command to control audio output, a control command to control receiving and sending data, a control command to control printing, and displays a screen corresponding to the generated control command. For instance, if a control command to control the screen is generated, the interface apparatus 100 displays a screen corresponding to the generated control command, and if a control command to control printing is generated, the interface apparatus 100 displays a screen showing printing is being conducted.

The interface apparatus 100 also controls the operation of the interlocking apparatus 10 by sending such a control command to the interlocking apparatus 10.

The interlocking apparatus 10 comprises a monitor 11, a printer 13, an MPEG Audio Layer-3 player (MP3P) 15, and a personal computer (PC) 17.

The monitor 11 receives a control command from the interface apparatus 100 and performs the usual functions of a monitor according to the received control command. For instance, the monitor 11 may display a moving image or still image using image data received from the interface apparatus 100, according to the control command to control image output.

The printer 13 receives a control command from the interface apparatus 100 and performs the usual functions of a printer according to the received control command. For instance, the printer 13 may print a photo using photo data received from the interface apparatus 100, according to the control command to control printing.

The MP3P 15 receives a control command from the interface apparatus 100 and performs the usual functions of a MP3P according to the received control command. For instance, The MP3P 15 may receive/send or reproduce audio using audio data received from the interface apparatus 100, according to the control command to control input or output of audio data.

The PC 17 receives a control command from the interface apparatus 100 and performs the usual functions of the PC 17 according to the received control command. For instance, the PC 17 may store, execute, or process data received from the interface apparatus 100, according to the control command to control data transmission.

As such, a user may manipulate an interface more easily and conveniently by using the interface apparatus 100 and an interlocking apparatus 10 which is interlocked with the interface apparatus 100, and obtain the result of the interface manipulation.

FIG. 2 is a schematic view illustrating the interface apparatus 100 according to an exemplary embodiment of the present invention. As illustrated in FIG. 2, the interface apparatus 100 comprises a multi-media function block 110, a touch screen 120, a motion sensor 130, a control unit 140, a communication module 150, and a storage unit 160.

The multi-media function block 110 displays a screen corresponding to the interface manipulation by a user. More specifically, the multi-media function block 110, in order to display a screen corresponding to the interface manipulation by the user, generates a GUI such as a menu item or contents item, and performs a function corresponding to the interface manipulation such as reproducing contents like a moving image, still image, music, or text.

The touch screen 120 serves as a tool to receive a command input by interface manipulation such as touch by the user. The touch screen 120 displays a screen corresponding to the interface manipulation by the user.

For instance, if an interface manipulation for reproducing a moving image is input by a user, the control unit 140, which will be explained later, generates a control command for reproducing the moving image, and the touch screen 120 receives the generated control command to reproduce a moving image according to the control command.

The control command for reproducing the moving image may be generated by touch sensed on the touch screen 120, or may be generated by motion sensed via the motion sensor 130 which will be explained later, or may be generated by the combination of the touch input sensed on the touch screen 120 and the motion sensed via the motion sensor 130.

The control command for reproducing a moving image may be transmitted to the touch screen 120 to reproduce the moving image on the touch screen 120, or may be transmitted to the monitor 11, which is one of interlocking apparatuses 10, to reproduce the moving image from the monitor 11.

The touch screen 120 receives an interface manipulation such as touch and transmits information regarding the sensed touch to the control unit 140. The information regarding the sensed touch will be explained later.

The motion sensor 130 serves as a tool to receive a manipulation of a 3-dimensional motion by a user. The motion sensor 130 mainly senses a finger movement of a user, and transmits the information regarding the sensed motion to the control unit 140. The information regarding the sensed motion will be explained later.

The control unit 140 generates a control command using the input touch or the 3-dimensional motion sensed via the motion sensor 130. More specifically, the control unit 140 extracts information regarding the 2-dimensional coordinates of the section touched via the touch screen 120, and coordinate information and configuration information regarding the 3-dimensional coordinates of the sensed 3-dimensional motion, and generates a control command using the extracted 2-dimensional coordinates information, the 3-dimensional coordinate information, and configuration information.

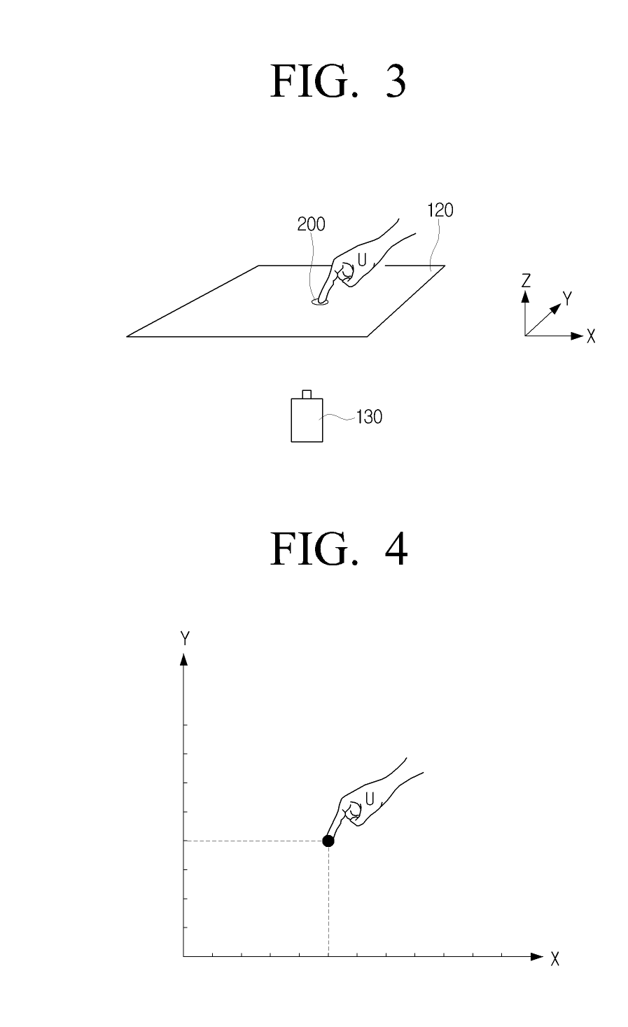

In order to provide better understanding, the above feature will be explained with reference to FIG. 3 to FIG. 6.

FIG. 3 is a schematic view illustrating a user inputting a command by touch. FIG. 3 schematically illustrates the touch screen 120 and the motion sensor 130 as part of the interface apparatus 100.

As illustrated in FIG. 3, the touch screen 120 is formed perpendicular with a Z-axis in order to receive touch, and an X-axis and Y-axis are formed parallel to the touch screen 120. The motion sensor 130 is disposed on the lower part of the touch screen 120 in order to sense the 3-dimensional motion by a user on the touch screen 120.

As such, a user may manipulate an interface by touching the touch screen 120, and accordingly control the touch screen 120 to generate a control command according to the interface manipulation. As illustrated in FIG. 3, a pointer 200 can be displayed on the touched section.

FIG. 4 is a schematic view provided to explain how to generate a control command by using the touch input through the interface manipulation of FIG. 3.

If a user touches the touch screen 120, the control unit 140 extracts the 2-dimensional coordinate information of the section touched via the touch screen 120. The control unit 140 extracts the coordinate information, “5”, as an X-axis coordinate of the touched section, and the coordinate information, “4”, as a Y-axis coordinate of the touched section. The control unit 140 generates a control command using such extracted coordinate information.

For instance, the control unit 140 displays the pointer 200 on the coordinate (5, 4) of the touch screen 120 using the above coordinate information (5, 4). That is, the control unit 140 generates a control command for displaying the pointer 200 on the coordinates (5, 4) of the touch screen 120.

For convenience of explanation, the process of generating a control command for controlling the touch screen 120 was described above. However, the same technical feature can also be applied to the process of generating a control command for controlling the interlocking apparatus 10.

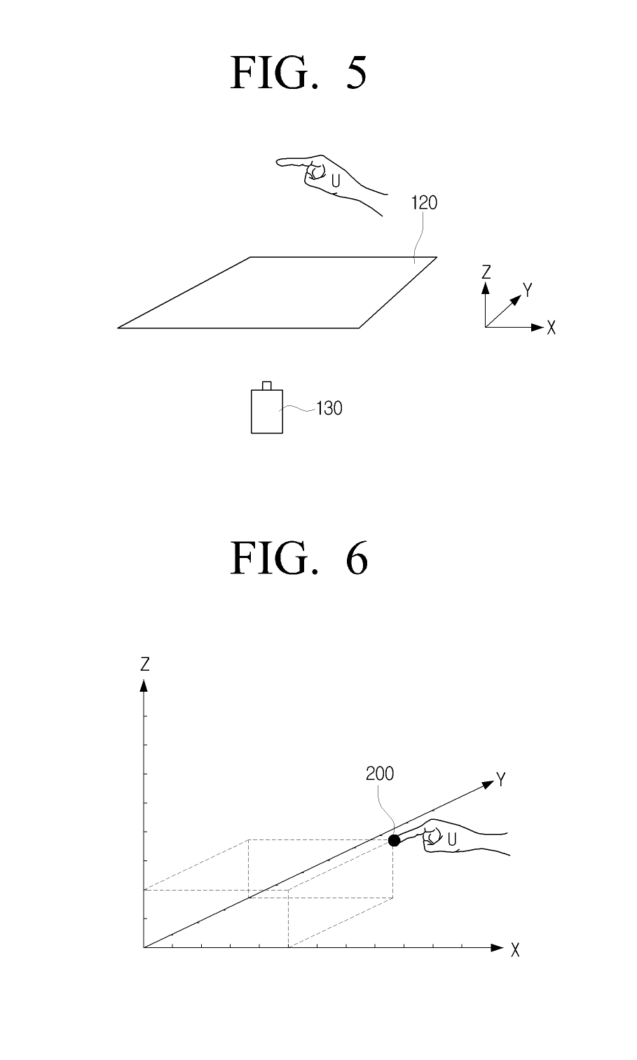

FIG. 5 is a schematic view illustrating how motion by a user is sensed. FIG. 5 also schematically illustrates the touch screen 120 and the motion sensor 130 as part of the interface apparatus 100.

If a user manipulates the interface by moving his or her fingers above the touch screen 120, the motion sensor 130 disposed under the touch screen 120 senses the motion caused by the interface manipulation. The motion sensor 130 senses the motion along the X-axis, Y-axis, and Z-axis.

If the motion caused by the interface manipulation is sensed, the control unit 140 controls the touch screen 120 by generating a control command corresponding to the interface manipulation.

FIG. 6 is a schematic view provided to explain how to generate a control command using the motion sensed from the interface manipulation in FIG. 5.

If motion by a user is sensed through the motion sensor 130, the control unit 140 extracts 3-dimensional coordinates information regarding the motion above the touch screen 120. The control unit 140 extracts the coordinate information, “5”, as an X-axis coordinate, the coordinate information, “4”, as a Y-axis coordinate, and the coordinate information, “2”, as a Z-axis coordinate. The control unit 140 generates a control command using such extracted coordinate information.

The control unit 140 displays the touch screen 120 or the monitor 11 corresponding to the above 3-dimensional coordinate information (5, 4, 2). For instance, the control unit 140 may generate a control command to display a pointer or an item on the point of the touch screen 120 having coordinates (X, Y) of (5, 4), or may generate a control command to display a pointer or an item on the point having coordinates (X, Z) of (5, 2) of the monitor 11 which is located perpendicular to the touch screen 120.

As such, the control unit 140 generates a control command using the extracted coordinate information.

The control unit 140 generates a control command using a configuration information regarding motion.

The configuration information regarding motion means information of motion configuration for specific interface manipulation. For instance, if a user manipulates the interface with one finger unfolded and other fingers folded, the configuration of unfolded and folded fingers can be configuration information regarding motion.

The control unit 140 can determine how a user manipulates the interface using the extracted motion configuration information via the motion sensor 130 (for example, if a user intends to manipulate the interface using only one unfolded finger), and generate a control command corresponding to the determined configuration information.

If a user manipulates the interface by extending one finger, the control unit 140 extracts configuration information regarding the motion within the sensing range of the motion sensor 130, extracts the coordinate information of the end point of the user's extended finger using the motion configuration information, and generates a control command corresponding to the interface manipulation using the end point of the extended finger.

The control unit 140 may obtain information regarding the location indicated by the extended finger on the touch screen 120 or the monitor 11 by using the motion configuration information extracted by the motion sensor 130. For instance, information regarding the point at which a finger points (the point at which the extended line of the end point of the finger contacts the touch screen 120 or the monitor 11) can be determined using such information as the 3-dimensional information regarding the end point of the finger and the angle of the user's wrist, the back of the user's hand, and the extended finger.

The control unit 140 may generate a control command using the combination of touch and motion. More specifically, the control unit 140 may generate an independent control command by combining 2-dimensional coordinate information, 3-dimensional coordinate information, and motion configuration information, which is different from a control command generated from each piece of information (such as 2-dimensional coordinate information, 3-dimensional coordinate information, or motion configuration information).

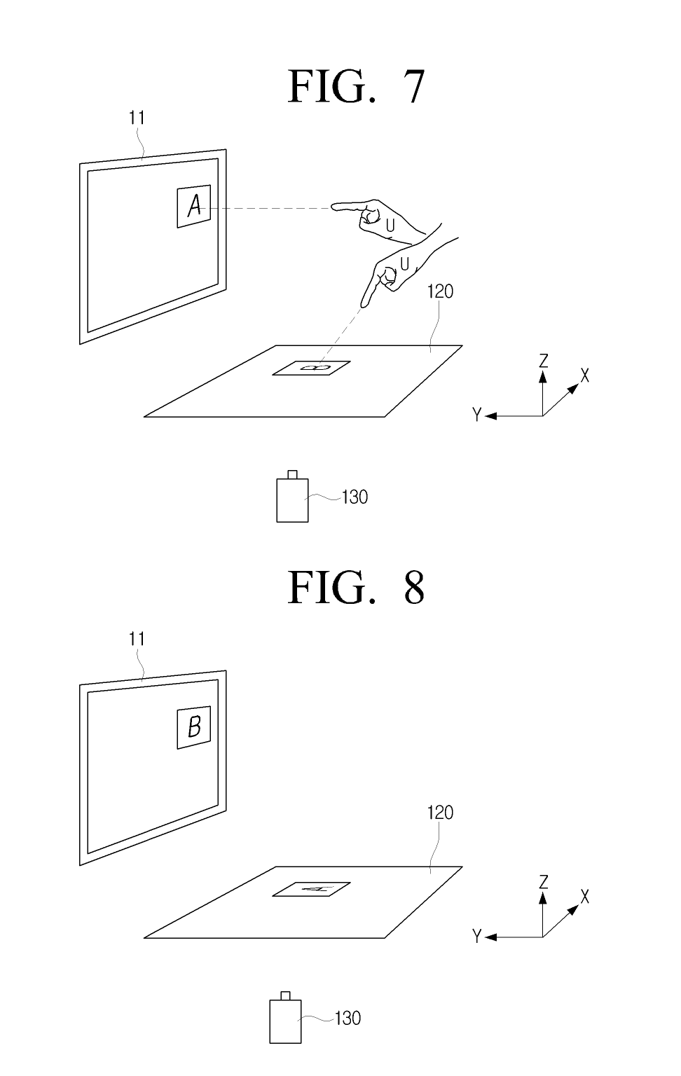

FIG. 7 and FIG. 8 are schematic views provided to explain how to generate a control command using the combination of touch and motion.

As illustrated in FIG. 7, if a certain portion of the touch screen 120 is designated through the 2-dimensional coordinate information of the input touch and a certain portion of the monitor 11 which is one of the interlocking apparatuses is designated through the 3-dimension coordinate information of the sensed motion and configuration information, the control unit 140 generates a control command using the combination of the touch and motion.

If only touch is sensed, a pointer may be generated on the certain portion of the touch screen 120 designated by the 2-dimensional coordinate information regarding the touch, or a control command may be generated to select the item displayed on the certain portion.

If only motion is sensed, a pointer may be generated on the certain portion of the interlocking apparatus 130 designated by the 3-dimensional coordinate information regarding the touch, or a control command may be generated to select the item displayed on the certain portion.

If touch and motion are sensed at the same time as shown in FIG. 7, a control command may be generated to exchange item A which exists on a certain portion of the touch screen 120 designated by the 2-dimensional coordinate information regarding the touch with item B which exists on a certain portion of the interlocking apparatus 130 designated by the 3-dimensional coordinate information regarding the motion as shown in FIG. 8.

As such, the control command generated by the combination above is a new control command and has nothing to do with a control command generated by touch or motion.

Referring to FIG. 2 again, the control unit 140 generates a control command by using touch sensed on the touch screen 120 or motion sensed within in the range of the motion sensor 130, and controls the operation of the multi-media function block 110 according to the generated control command.

The control unit 140 transmits the generated control command to the communication module 150 in order to control the interlocking apparatus 10 according to the generated control command.

The communication module 150 is connected to the interlocking apparatus 10 so as to communicate with the interlocking apparatus 10 according to the conventional communication method. The communication module 150 transmits the control command generated by the control unit 140 to the interlocking apparatus 10 by using the 2-dimensional coordinate information, 3-dimensional coordinate information, and motion configuration information.

For instance, if the interlocking apparatus (not shown) is formed parallel with the X-axis of the interface apparatus 100 and perpendicular to the interface apparatus 100, it is assumed that the 3-dimensional coordinate information is (5, 4, 2), and the user's finger points in the direction of (5, 2) on the interlocking apparatus 10. In this case, the control unit 140 generates a pointer at (5, 2) on the interlocking apparatus (not shown), or generates a control command to select an item at (5, 2) on the interlocking apparatus (not shown). The control unit 140 then transmits the control command to the communication module 150, and controls the communication module 150 to transmit the control command to the interlocking apparatus (not shown).

Accordingly, the interlocking apparatus (not shown) which receives the control command from the communication module 150 displays a screen corresponding to the received control command.

The storage unit 160 is storage medium for storing programs to drive the interface apparatus 100 and may be realized as a memory or a Hard Disk Drive (HDD).

The storage unit 160 stores the type of control command corresponding to the touch and motion set by a predetermined method, and the control unit 140 generates a control command according to a predetermined method based on the type of control command stored in the storage unit 160.

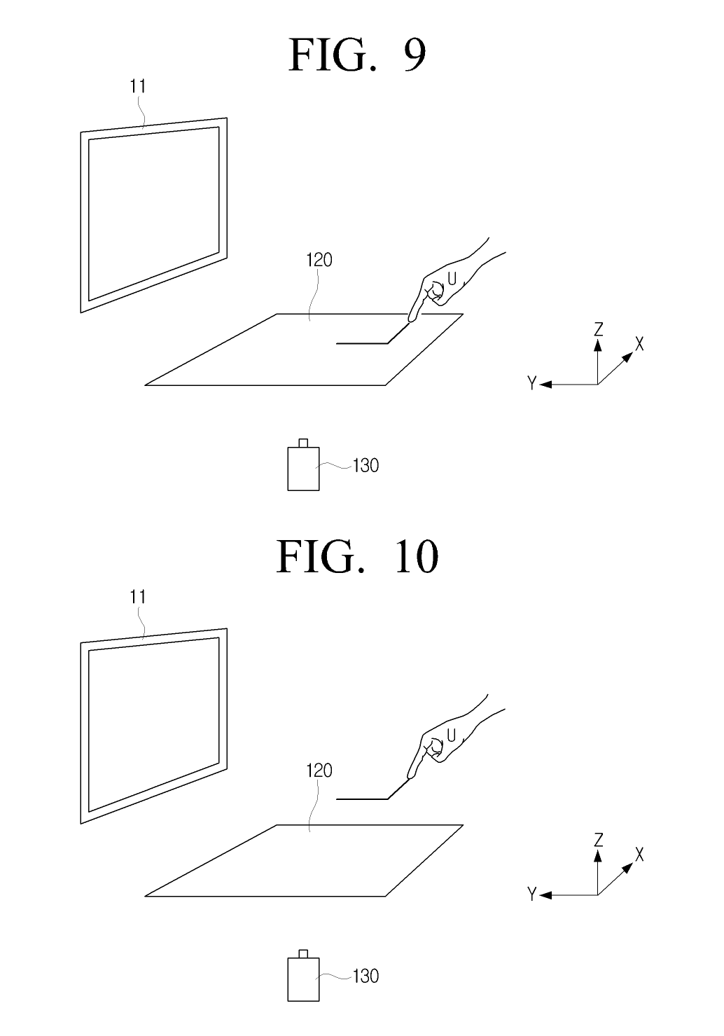

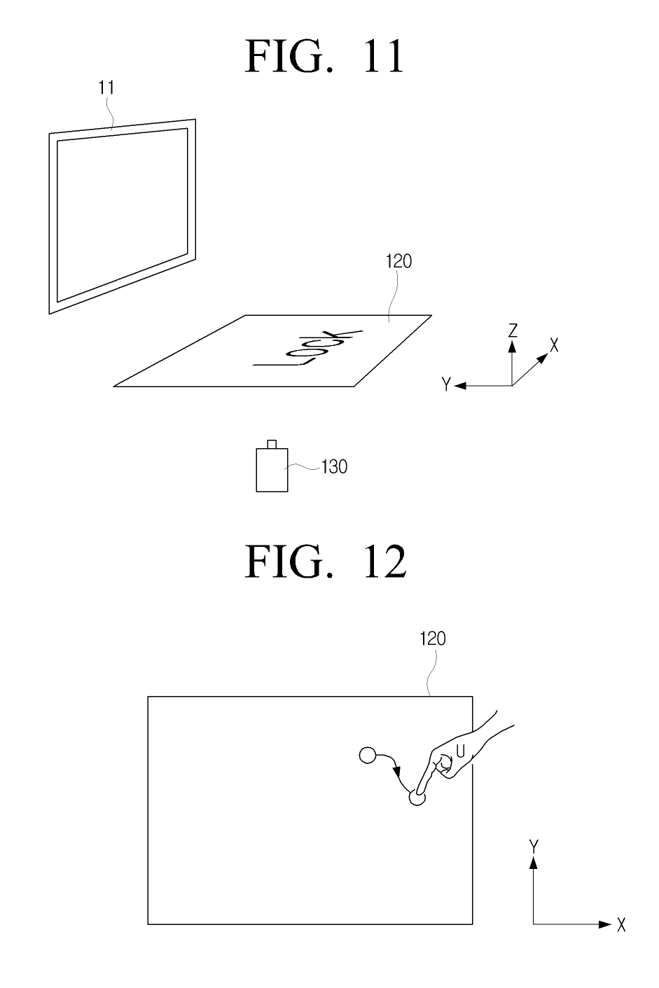

This will be explained with reference to FIGS. 9 to 11. FIG. 9 to FIG. 11 are schematic views provided to explain how to generate a control command using a predetermined method.

If touch is in the shape of the letter “L” on the touch screen 120 as shown in FIG. 9 or if motion in the shape of the letter “L” is sensed using the motion sensor 130 as shown in FIG. 10, the control unit 140 generates a control command in accordance with the sensed touch “L” or motion “L” to lock the use of the interface apparatus and display a screen showing that the use of the interface apparatus is locked.

The touch or motion in the shape of the letter “L” may be the touch or motion based on a predetermined method. Likewise, the control command to lock the use of the interface apparatus and to display a screen showing that the use of the interface apparatus is locked may be a control command corresponding to the touch or motion based on a predetermined method.

Such a type of control command is stored in the storage unit 160, and the control unit 140 generates a control command according to a predetermined method based on the type of control command stored in the storage unit 160.

As such the interface apparatus 100 provides an environment in which a user can manipulate a GUI more easily and conveniently using the touch screen 120 or the motion sensor 130.

The interface method will be explained in greater detail below.

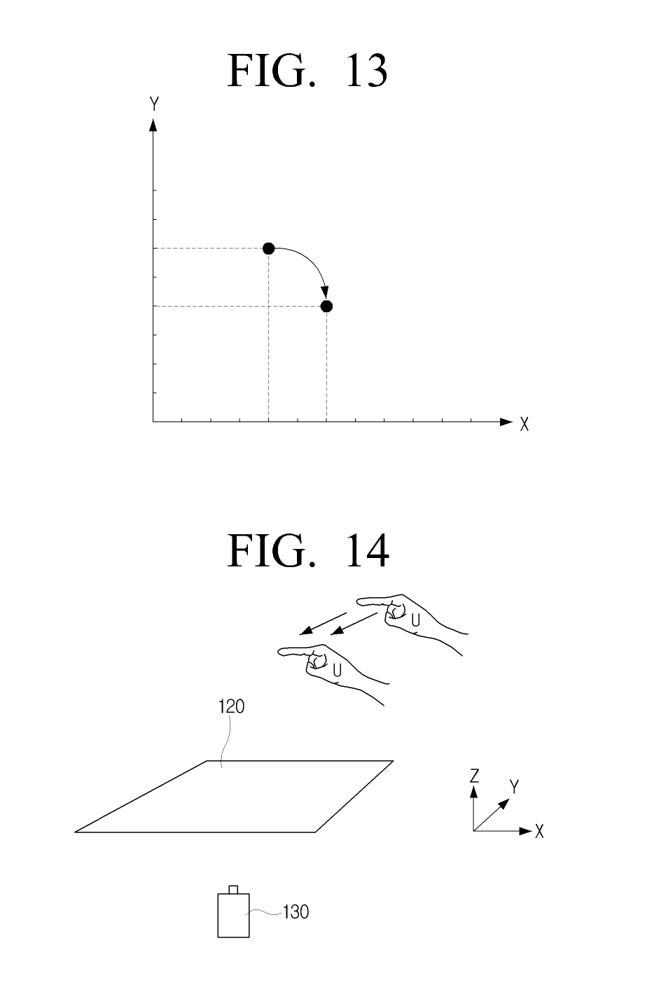

FIG. 12 and FIG. 13 are schematic views provided to explain the concept of dragging by touch.

As illustrated in FIG. 12, a user may perform interface manipulation by touching and dragging one item from a certain location of the touch screen 120 and changing the touched point while touching the screen.

In this case, the control unit 140 may extract the track of the touched point as 2-dimensional coordinate information, and generate a control command to move the item along the track of the touched point using the extracted coordinate information, as shown in FIG. 13.

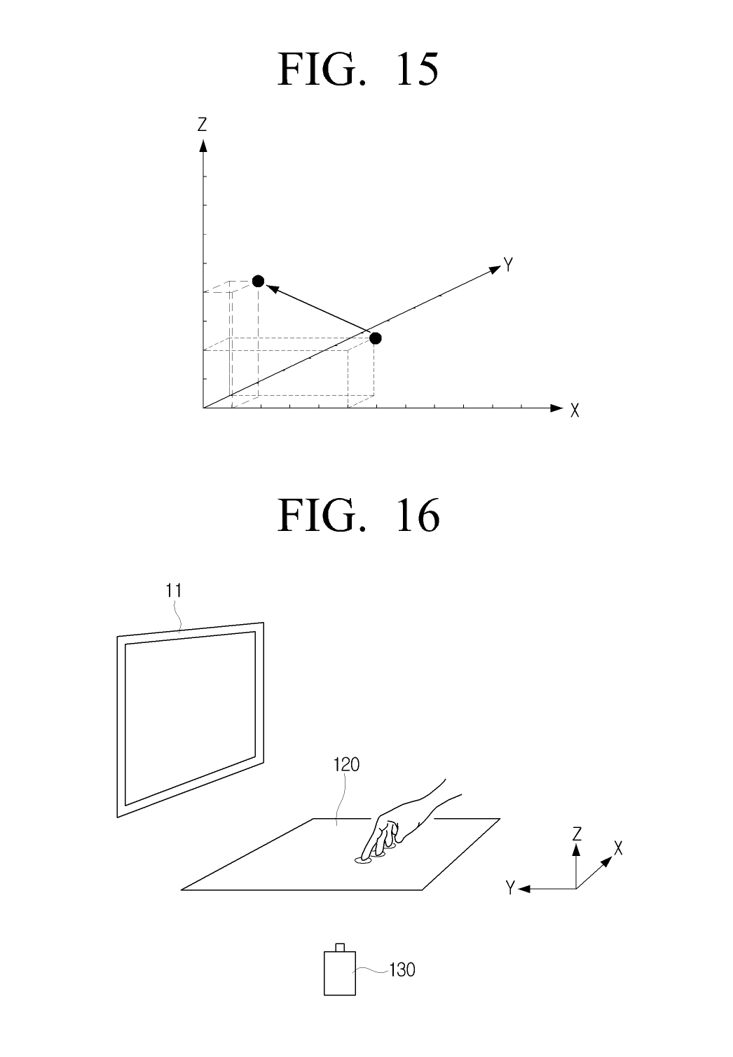

FIG. 14 and FIG. 15 are schematic views provided to explain the concept of dragging motion.

As illustrated in FIG. 14, a user may perform interface manipulation by dragging a designated item displayed on the screen of the touch screen 120 or the interlocking apparatus 10 through motion within the range able to be sensed by the motion sensor 130.

In this case, the control unit 140 may extract the track of the point moved by motion as 3-dimensional coordinate information, and generate a control command to move the item displayed on the touch screen 120 or the monitor 11 along the track of the motion by using the extracted coordinate information, as shown in FIG. 15.

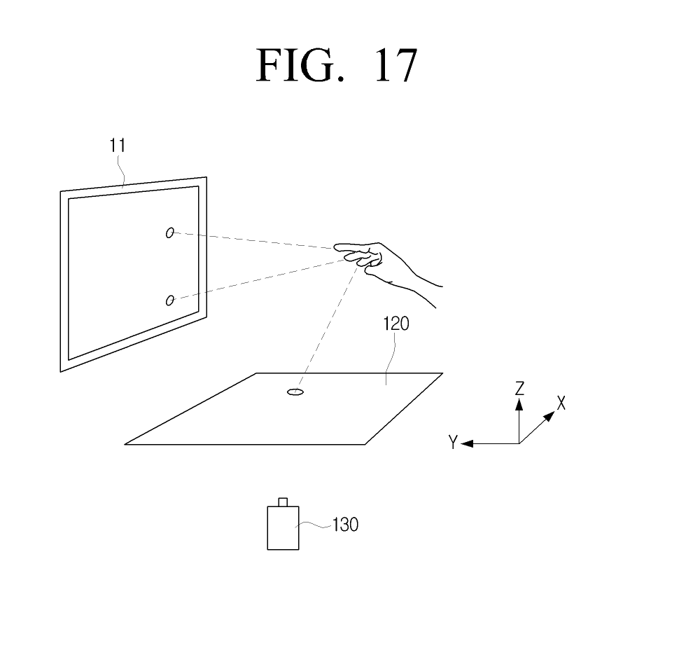

FIG. 16 and FIG. 17 are schematic views provided to explain the concept of multi-touch and multi-motion.

As illustrated in FIG. 16, the touch screen 120 may receive a plurality of touches simultaneously, and the control unit 140 may generate three control commands for respective touch, or may generate one control command for the plurality of touches.

For instance, if three points are touched on the touch screen simultaneously, the control unit 140 may generate three control commands to highlight each item on each spot, or may generate a control command to change the interface apparatus 100 or the monitor to a stand-by mode.

In the above explanation, the storage unit 160 stores the type of control command corresponding to the touch based on a predetermined method, and the control unit 140 generates a control command according to the predetermined method based on the type of control command stored in the storage unit 160. In the above example, touching the three points simultaneously may be the predetermined method. If the three points are touched simultaneously, the type of control command to change the interface apparatus 100 or the monitor 11 to a stand-by mode may be stored in the storage unit 160.

As illustrated in FIG. 17, the motion sensor 130 may sense a plurality of motions simultaneously, and the control unit 140 may generate three control commands for respective touch, or may generate one control command for the plurality of motions.

For instance, if a multi-motion designating three points is sensed by the motion sensor 130, and two motions designate a point of the interlocking apparatus 10 and one motion designates a point of the touch screen 120 as shown in FIG. 17, the control unit 140 may generate three control commands to select each item on each point, or may generate a control command to turn off the power of the interface apparatus 100 or the interlocking apparatus 10.

In this case, the type of control command corresponding to the motion based on the predetermined method is also stored in the storage unit 160. If the two motions designate a point of the interlocking apparatus 10, and one motion designates a point of the touch screen 120, the type of control command to change the power of the interface apparatus 100 or the interlocking apparatus 10 to a stand-by mode may be pre-stored in the storage unit 160.

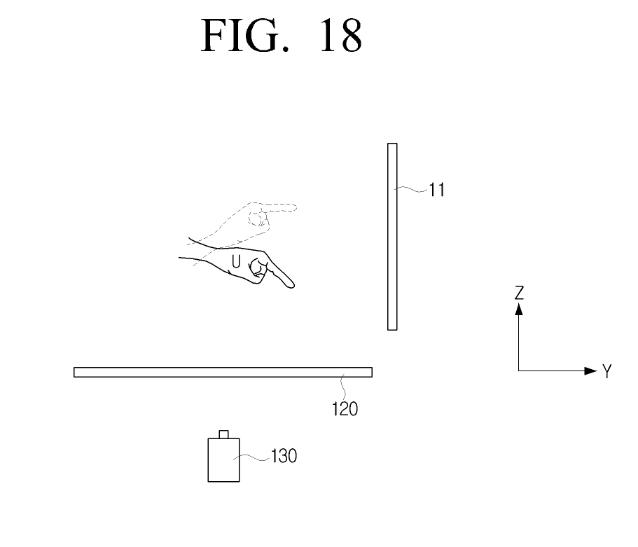

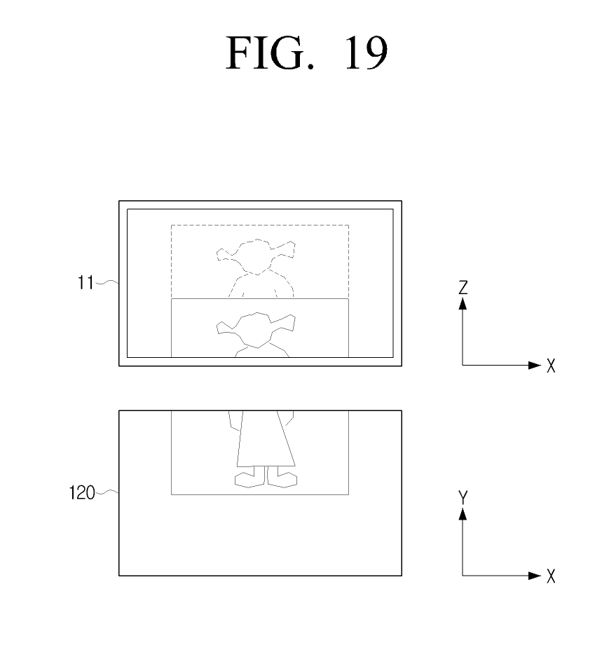

FIG. 18 and FIG. 19 are schematic views provided to explain the concept of interlocked manipulation between the interface apparatus 100 and the interlocking apparatus 10. For convenience of explanation, the interface apparatus 100 and the monitor 11 in FIGS. 7 to FIG. 11 and FIG. 16 and FIG. 17 are illustrated again based on each axis.

A user may change a screen displayed on the touch screen 120 or the monitor through interface manipulation on the 3-dimensional motion sensor 130. FIG. 18 and FIG. 19 are examples to show interface manipulation in which a still image displayed on the monitor 11 is dragged into the touch screen 120.

As illustrated in FIG. 18, if a user points at a still image and moves his or her finger from the monitor 11 to the touch screen 120, the still image displayed on the monitor 11 is dragged in the direction of the touch screen 120 as illustrated in FIG. 19.

As such, a user may perform interlocked manipulation between the monitor 11 and the touch screen 120 through interface manipulation.

In this case, the control unit 140 generates a control command to pull down the still image below the screen and transmits the control command to the monitor 11. The control unit 140 also generates a control command to pull down the still image displayed on the monitor 11 from the screen and transmits the control command to the touch screen 120.

Dragging from the monitor 11 to the touch screen 120 has been explained above as an example of interlocked manipulation, however this is only an example presented for the convenience of explanation. Interlocked manipulation is applicable to forms of manipulations other than manipulation by dragging. That is, the monitor 11 and the touch screen 120 can be operated in the same way as a dual monitor.

Transmitting a still image from the monitor 11 to the touch screen 120 has been explained above as an example, however it is also possible to conversely transmit a still image from the monitor 11 to the touch screen 120.

If the interlocking apparatus 10 according to the exemplary embodiment of the present invention is not a monitor 11 but a printer 13, data can only be transmitted from the touch screen 120 to the printer 13. For instance, if a user performs interface manipulation to drag a still image displayed on the touch screen 120 in the direction of the printer 13, the still image is no longer displayed on the touch screen 120 and the still image can be output in the printer 13.

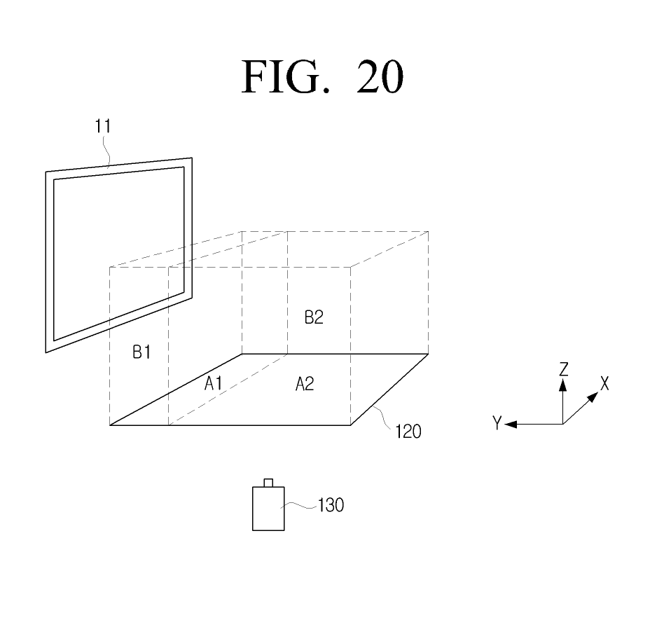

FIG. 20 is a schematic view provided to explain the concept of interface manipulation for portions of a screen set by a user.

As illustrated in FIG. 20, the touch screen 120 is divided into portions A1 and A2, and the vertical space on the touch screen 120 is divided into portions B1 and B2.

The control unit 140 may generate a different control command depending on which portion of the screen the interface manipulation has been performed on.

For instance, the control unit 140 may generate a different control command depending on which portion of the screen among A1, A2, B1, and B2, interface manipulation is performed on. In particular, if interface manipulation is performed in A1 or A2, it is recognized as a manipulation interlocked with the monitor 11, and if interface manipulation is performed in B1 or B2, it is recognized as manipulation of the touch screen 120, not interlocked with the monitor 11.

The reason for generating a different control command depending on the portions of the screen is to prevent interface manipulation being performed inadvertently.

If all touches sensed in A1 and A2 on the touch screen 120 are recognized as interlocked manipulation, it may be difficult for the user to perform interface manipulation for only the touch screen 120 such as changing only the screen displayed on the touch screen 120.

Likewise, if all motions sensed in B1 and B2 through the motion sensor 130 are recognized as interlocked manipulation, and it may be difficult for the user to perform interface manipulation for only the touch screen 120 such as changing only the screen displayed on the touch screen 120.

Therefore, only a certain part A1 of the touch screen 120 and a certain part B1 of the touch screen 120 are recognized as interface manipulation for interlocked manipulation.

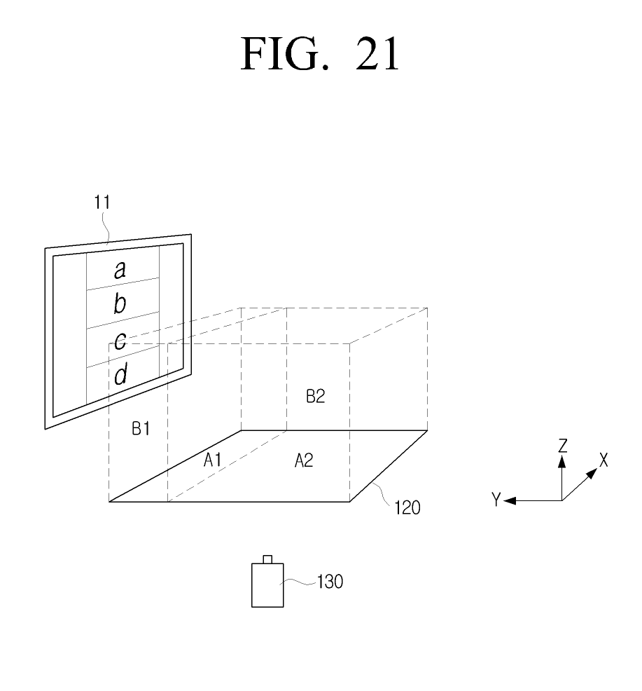

FIGS. 21 to FIG. 23 are schematic views provided to explain the concept of interface manipulation for divided sections.

The monitor 11 of FIG. 21 displays a menu including such menu items as “a”, “b”, “c”, and “d”. Item “c” among the menu items displayed on the monitor 11 is a manipulation associating the touch screen 120 and the monitor 11, so a user may select item “c” from either A1 or B1 by interface manipulation.

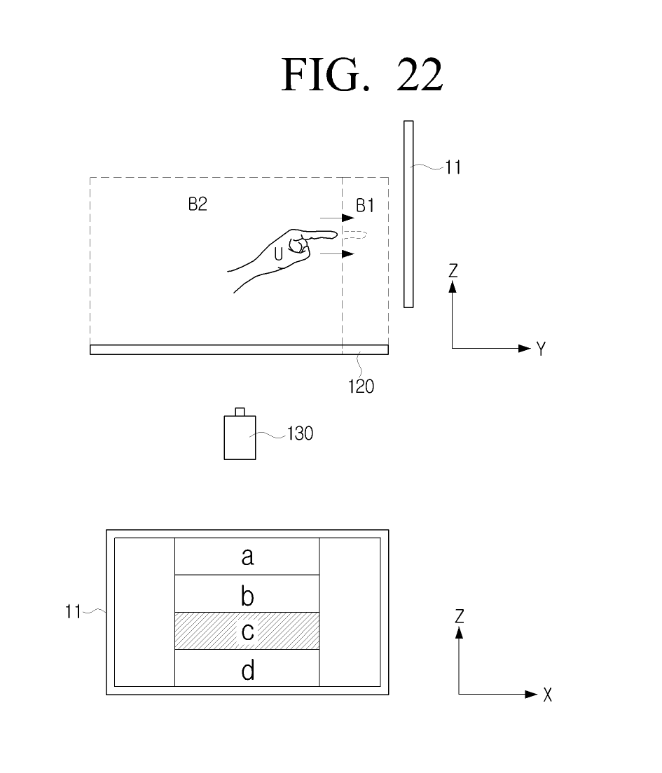

FIG. 22 is a schematic view showing selection of an item using a vertical space on the touch screen 120. If a user's motion is sensed in B2 by the motion sensor 130, the control unit 140 does not generate a control command associating the motion with the monitor 11.

However, if a user's motion is sensed in B1 by the motion sensor 130, the control unit 140 generates a control command to interlock the motion with the monitor 11 by using the 3-dimensional coordinate information of the sensed motion and the configuration information of the motion.

More specifically, the motion sensor 130 may determine the portion of the screen where a user's motion is sensed by sensing a user's motion within the range of the motion sensor 130 and extracting Y-axis coordinate information from the 3-dimensional coordinate information of the sensed motion.

As illustrated in FIG. 22, if a user's finger which was in B2 moves towards the monitor 11 in B1, the motion sensor 130 senses this motion and transmits the 3-dimensional coordinate information and the configuration information of the sensed motion to the control unit 140.

The control unit 140 identifies that the interface manipulation by the user is to select item “c” based on the extracted information of the 3-dimensional coordinate information and the configuration information of the sensed motion.

More specifically, the control unit 140 identifies that the interface manipulation by the user is to select item “c” based on the X-axis coordinate information and Y-axis coordination information from the 3-dimensional coordinate information of the sensed motion.

Accordingly, the control unit 140 generates a control command to select and highlight item “c”, transmits the control command to the monitor 11, and the monitor 11 highlights the item “c” and displays a screen corresponding to the item “c” according to the received control command.

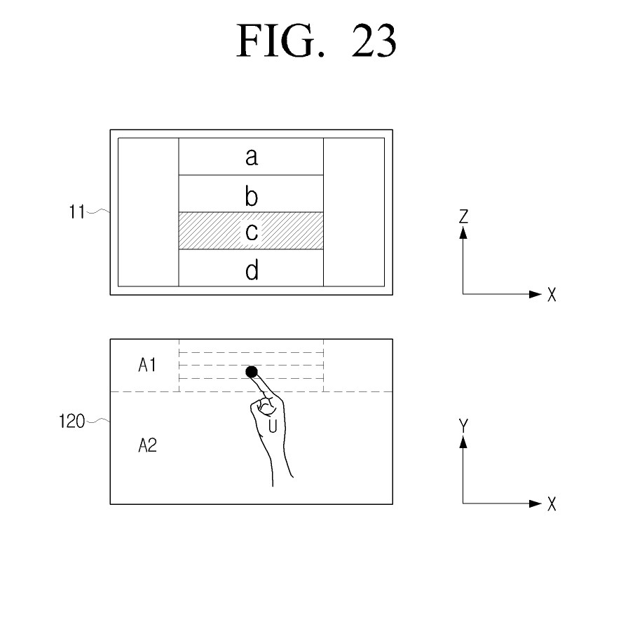

FIG. 23 is a schematic view showing selection of an item using the touch screen 120. If a user's touch is sensed in portion A2 of the touch screen 120, the control unit 140 does not generate a control command to interlock the sensed touch with the monitor 11.

However, if a user's touch is sensed in portion A1 of the touch screen 120, the control unit 140 generates a control command to interlock the sensed touch with the monitor 11 using the 2-dimensional coordinate information of the sensed touch.

More specifically, touch is sensed on the touch screen 120 by a user and the touch screen 120 extracts the Y-axis of the 2-dimensional coordinates of the sensed touch to identify where the user's touch is sensed.

As illustrated in FIG. 23, if a user's finger which was in A2 touches A1, the touch screen 120 senses this touch, and transmits the 2-dimensional coordinate information of the sensed touch to the control unit 140.

The control unit 140 extracts the 2-dimensional coordinate information of the sensed touch and identifies that the interface manipulation by the user is to select item “c” based on the extracted information.

More specifically, the control unit 140 identifies that the interface manipulation by the user is to select item “c” based on the extracted information using the X-axis coordinate information and Y-axis coordination information among the 2-dimensional coordinate information of the sensed motion.

Accordingly, the control unit 140 generates a control command to select and highlight item “c”, transmits the control command to the monitor 11, and the monitor 11 highlights the item “c” and displays a screen corresponding to item “c” according to the received control command.

Whether or not an operation is performed according to the section may change according to a user's settings.

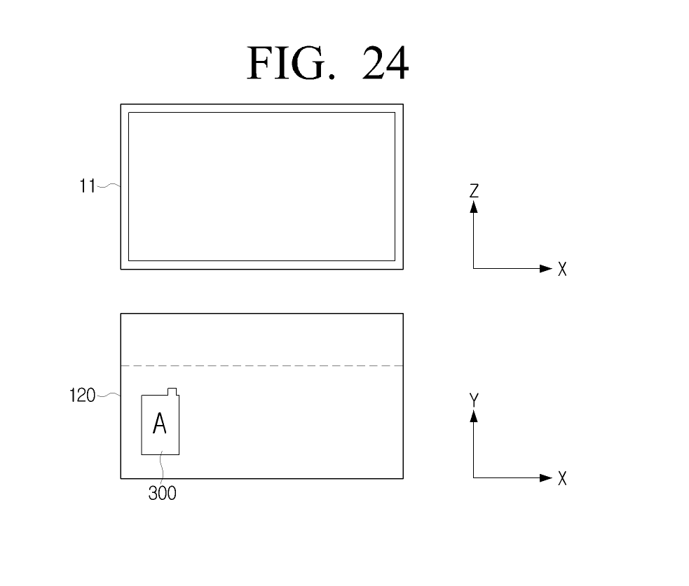

FIG. 24 to FIG. 26 are schematic views provided to explain the concept of interface manipulation by touch not by a user, but by a third device. In particular, FIG. 24 illustrates the third device A 300 being on the touch screen 120.

As show in FIG. 24, the touch screen 120 may recognize not only touch by a user but a device. The touch screen 120 receives touch by device A 300, and the control unit 140 generates a control command based on the sensed touch and transmits the control command to the touch screen 120, the monitor 11, or device A 300.

More specifically, if device A 300 is placed on the touch screen 120, the control unit 140 may generate a control command based on information regarding device A 200 such as information on the device's name, type, or contents stored on the device.

Such information regarding the device may be transmitted to the interface apparatus 100 by various methods.

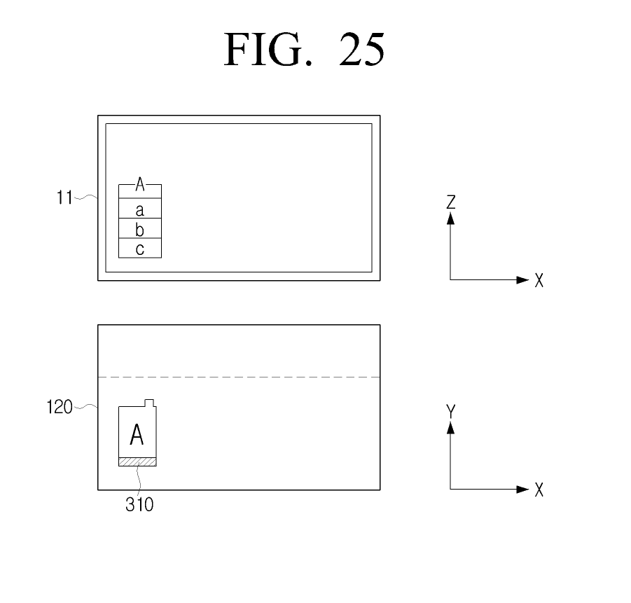

FIG. 25 shows an example in which information regarding device A 300 is extracted by a Radio Frequency Identification (RFID) card 310 which is attached to device A 300.

As shown in FIG. 25, an RFID card 310 on which information is stored regarding device A 300 is attached to device A 300.

Accordingly, if touch by the device A 300 is sensed by the touch screen 120, the control unit 140 generates a control command for device A 300 so that information regarding the device A 300 stored in the RFID card 100, which is contents information stored in the device A 300, can be transmitted to the touch screen 120 or the monitor 11.

Accordingly, the device A 300 transmits information regarding the device A 300 stored in the RFID card 310 to the communication module 150 of the interface apparatus 100.

The control unit 140 extracts information regarding device A 300 stored in the RFID card 100, which is the contents stored in device A 300, generates a control command to display the extracted contents on the monitor 11 or the touch screen 120, and transmits the control command to the monitor or the touch screen 120. Accordingly, the monitor 11 or the touch screen 120 displays the contents stored in the device A 300.

The interface apparatus 100 may further house an RFID reader (not shown) to extract information regarding device A 300 stored in the RFID card 310.

FIG. 25 shows an example in which information regarding device A 300 is extracted through a certain shape 330 of surface on the touch screen 120 touched by device A 300.

As shown in FIG. 25, device A 300, which contacts the touch screen 120, forms a certain shape 330, and the interface apparatus 100 pre-stores information regarding the device corresponding to the certain shape 330 in the storage unit 160.

If touch by device A 300 is sensed on the touch screen 120, the control unit 140 generates a control command for device A 300 so as to transmit contents stored in device A 300.

Accordingly, device A 300 transmits information regarding the contents stored therein to the communication module 150 of the interface apparatus 100.

The control unit 140 extracts information regarding device A 300, which is the contents stored in device A 300, from the communication module 150, generates a control command to display the extracted contents on the monitor 11 or the touch screen 120, and transmits the control command to the monitor 11 or the touch screen 120. Accordingly, the monitor or the touch screen 120 displays the contents stored in the device A 300 on the touch screen 120.

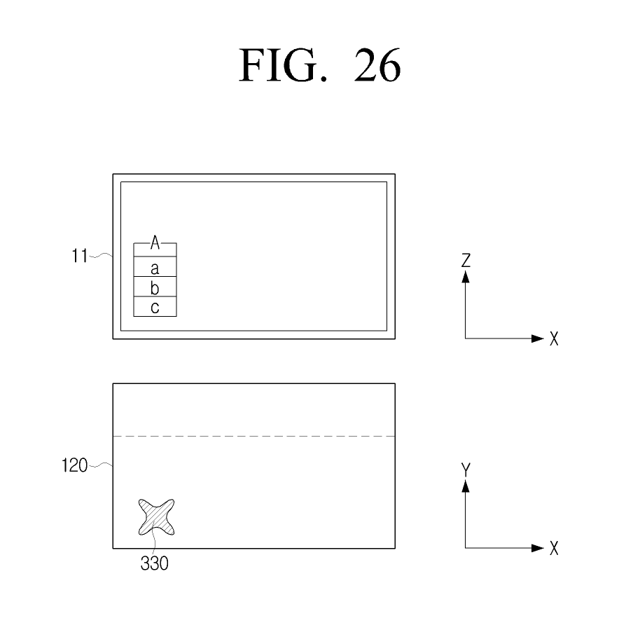

The above description regarding FIG. 25 and FIG. 26 is merely an example provided for the sake of convenience of explanation, and information regarding the device can be transmitted to the interface apparatus 100 by other means.

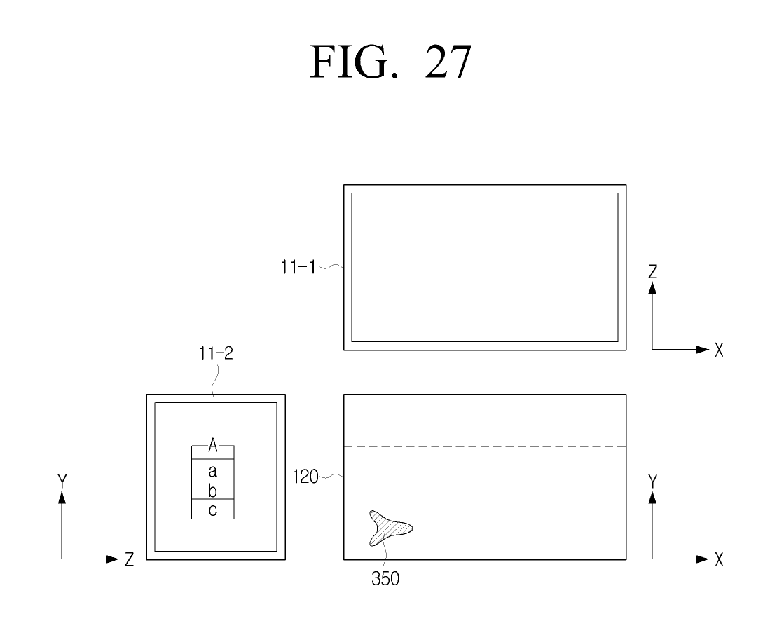

FIG. 27 is a schematic view provided to explain the concept of interface manipulation interlocked with two monitors, 11-1 and 11-2.

The interface apparatus 100 can be operated in association with more than two interlocking apparatuses. FIG. 27 is an example in which the touch screen 120 of the interface apparatus 100 is operated in association with two monitors, 11-1 and 11-2.

Accordingly, the control unit 140 may generate a control command using the touch sensed on the touch screen 120, and thereby control the operation of the touch screen 120, the first monitor 11-1, or the second monitor 11-2. In addition, the control unit 140 may generate a control command using the motion sensed by the motion sensor 130, and thereby control the operation of the touch screen 120, the first monitor 11-1, or the second monitor 11-2.

In the above description, information regarding a device is extracted by using a certain shape 350 on the contact surface of the touch screen 120. The control unit 140 may determine which interlocking apparatus the information regarding the device extracted by using the certain shape 350 on the contact surface, should be transmitted to.

For instance, as illustrated in FIG. 27, if a certain shape on the surface of the touch screen 120 touched by a device has a specific direction, the control unit 140 uses the direction information of the certain shape 330 and displays contents stored in the device on the second monitor 11-2, which corresponds to the direction information, from among the first monitor 11-1 and the second monitor 11-2. In this case, the storage unit 160 stores information regarding the certain shape 330 touched by the device, and obtain direction information by comparing the stored shape 330 with the touched shape 330.

This is mainly the case in which a user places a device to be in a certain direction when placing the device on the touch screen 120.

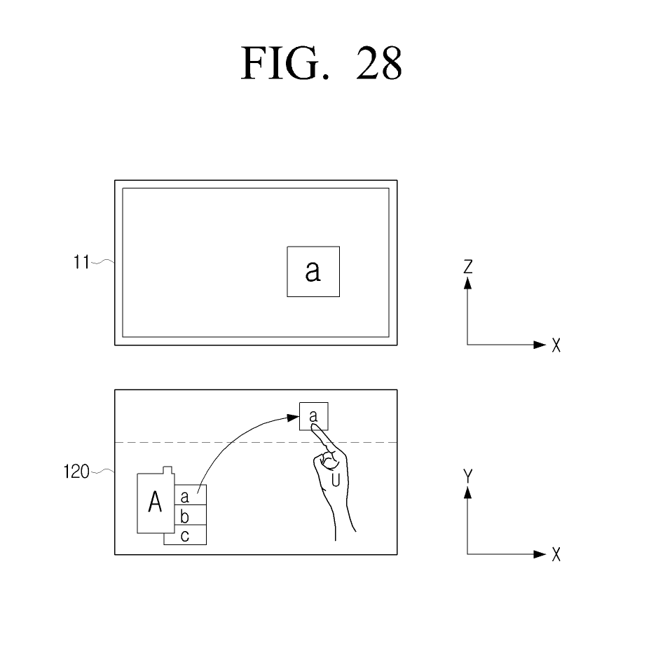

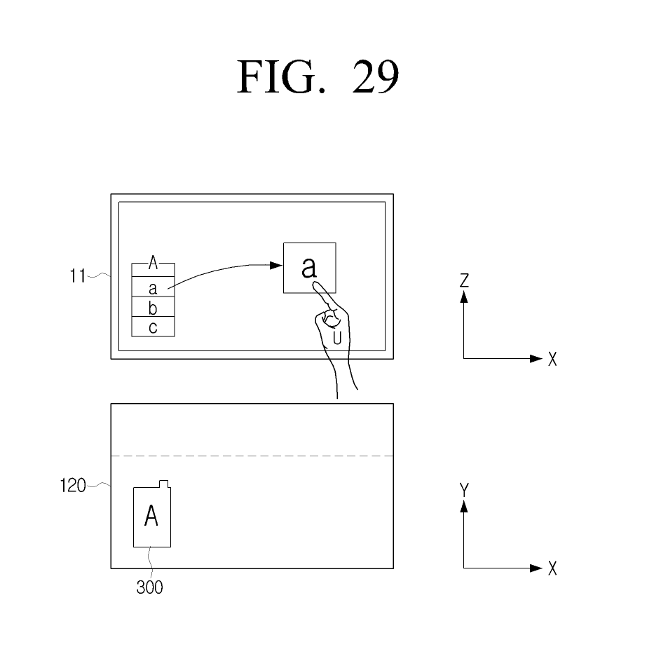

FIG. 28 and FIG. 29 are schematic views provided to explain the concept of another interface manipulation by touch by a device.

FIG. 28 is a schematic view illustrating that a menu item corresponding to touch by a device is displayed not on the monitor 11, but on the touch screen 120. As illustrated in FIG. 28, the menu item corresponding to touch by a device can be generated near the area where the device touches the touch screen instead of being generated directly on the monitor 11.

Accordingly, it is intuitively identified based on which operation the menu item is generated by and in which device the menu item has been stored.

A user may manipulate one item from among the menu items displayed on the touch screen 120 and display contents corresponding to the manipulated contents item on the monitor 11.

FIG. 29 is a schematic view illustrating that a menu item corresponding to touch by a device is displayed not on the touch screen 120, but on the monitor 11. As illustrated in FIG. 29, the menu item by device touch can be generated directly on the monitor 11 instead of being generated in the area where the device touches the touch screen 120 or near the area where the device touches the touch screen 120.

A user may manipulate one item from among the menu items displayed on the monitor 11 and display contents corresponding to the manipulated contents item on the monitor 11. This is the case in which contents item is manipulated not by touch but by sensing a user's motion.

Accordingly, a user may display a screen corresponding to the manipulated item on the monitor 11 by manipulating the generated menu item on the monitor 11. An example is the case in which the size of the touch screen 120 is not big enough to display a screen corresponding to an item.

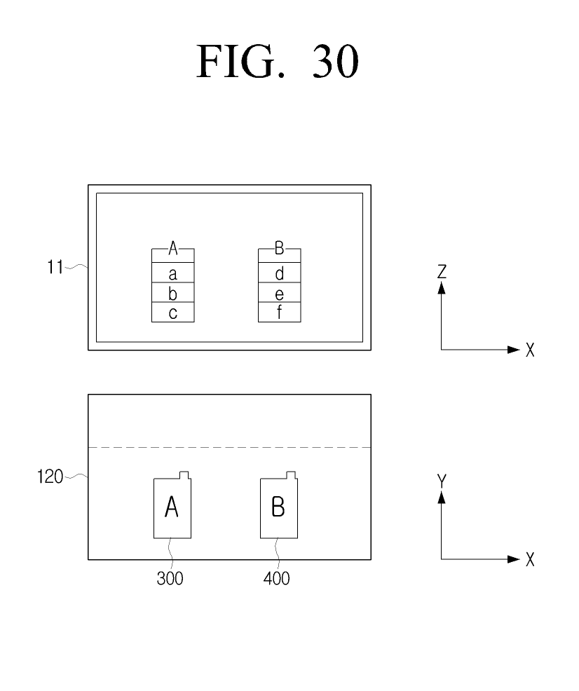

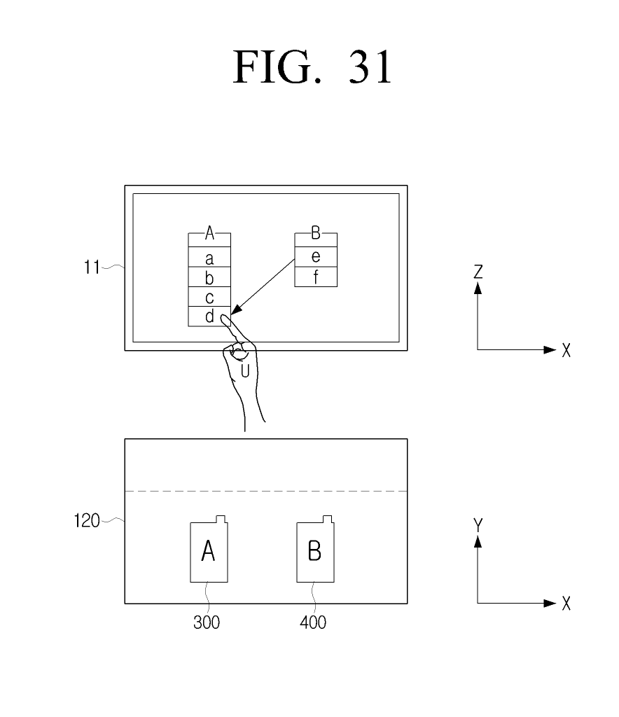

FIG. 30 and FIG. 31 are schematic views illustrating respective menu item corresponding to touch by a multi-device, using two devices, being displayed.

As illustrated, if device A 300 and device B 400 are disposed on the touch screen 120, the touch screen 120 senses touch by the device and the control unit 140 extracts information regarding device A and device B based on touch input by the device.

FIG. 30 is a schematic view illustrating that the menu item providing information regarding device A and the menu item providing information regarding device B are displayed on the monitor 11. The menu item regarding contents stored on device A is displayed on the monitor 11 and the menu item regarding contents stored on device B is also displayed.

Accordingly, a user may obtain information regarding more than two devices simultaneously.

As illustrated in FIG. 31, a user identifies information regarding more than two devices and sends/receives contents stored in each device conveniently.

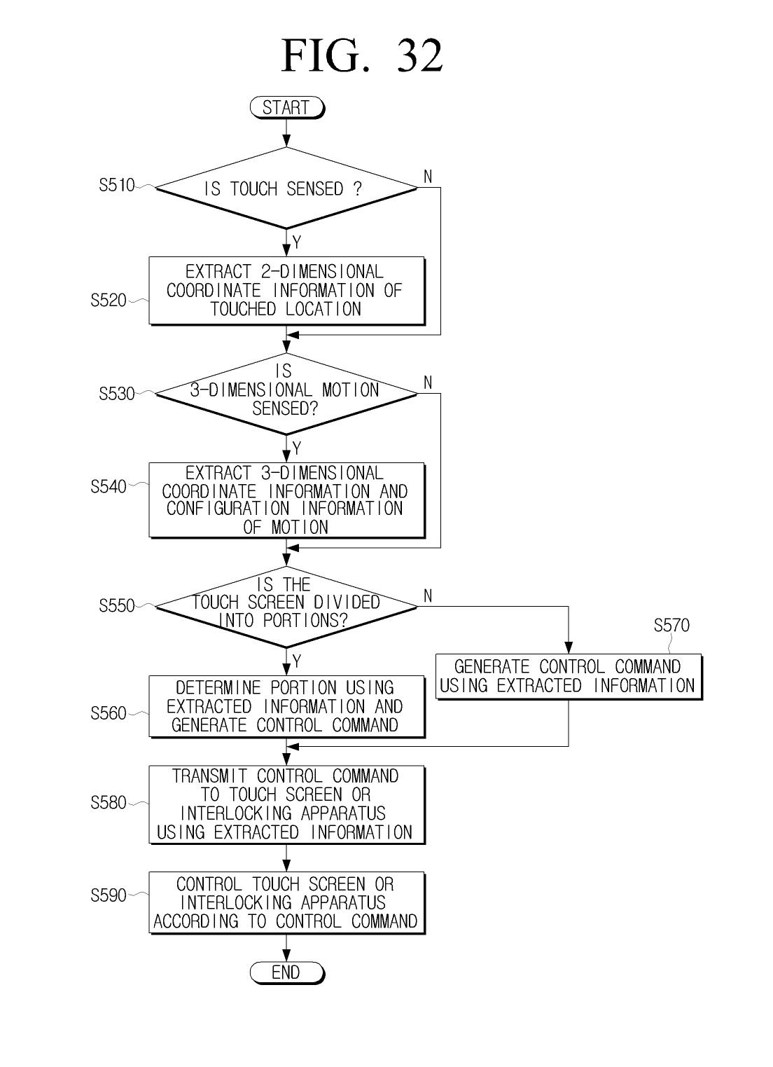

FIG. 32 is a flow chart provided to explain the interface method according to the exemplary embodiment of the present invention.

The control unit 140 firstly determines whether touch by a user is sensed on the touch screen 120 (S510). If a user's touch is sensed (S510-Y), the control unit 140 extracts the 2-dimensional coordinate information of the touched location (S520).

The control unit 140 then determines whether motion by a user is sensed on the motion sensor 130 (S530). If a user's touch is input (S530-Y), the control unit 140 extracts the 3-dimensional coordinate information of the motion and the motion configuration information (S540).

The control unit 140 determines whether the screen has been divided into portions of the screen (S550). If the screen has been divided (S550-Y), the control 140 identifies the portion using the extracted information and generates a control command based on the identified portion (S560). However, if the screen has not been divided (S550-N), the control 140 generates a control command using only the extracted information (S570).

The control unit 140 transmits the control command to the touch screen 120 or the interlocking apparatus 10 using the extracted information (S580), and the touch screen 120 or the interlocking apparatus 10 is operated according to the received control command (S590).

Accordingly, a user may intuitively manipulate a GUI with more ease and convenience.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An interface apparatus comprising:
a touch screen which senses touch;
a motion sensor which senses motion in a 3-dimensional space; and
a control unit which generates at least one of a first control command based on the touch, a second control command based on the motion, and a third control command based on interlocked manipulation of the touch and motion.

2. The interface apparatus as claimed in claim 1, wherein the control unit extracts at least one information from among the 2-dimensional coordinate information of the touch, the 3-dimensional coordinate information of the motion, and the configuration information of the motion, and generates at least one control command from among the first to third control command using the extracted information.

3. The interface apparatus as claimed in claim 1, wherein the first to third control commands control at least one apparatus from among the interface apparatus and the external apparatus connected to the interface apparatus.

4. The interface apparatus as claimed in claim 3, wherein the control unit transmits at least one control command from among the first to third control commands to at least one of the touch screen and the external apparatus based on at least one control command from among the first to third control commands.

5. The interface apparatus as claimed in claim 1, wherein the control unit changes a screen displayed on the touch screen based on at least one control command from among the first to third control commands.

6. The interface apparatus as claimed in claim 1, wherein the third control command is a separate control command which is different from a combination of the first and second control commands.

7. The interface apparatus as claimed in claim 1, wherein the touch screen or the 3-dimensional space are divided into a plurality of portions,
wherein the control unit generates a different control command depending on the portion of the screen on which touch, the motion, or a combination of the touch and motion is sensed.

8. The interface apparatus as claimed in claim 7, wherein the plurality of portions include a first portion to control the external apparatus connected to the interface apparatus and a second portion to control the touch screen.

9. The interface apparatus as claimed in claim 1, wherein the control unit generates a first control command regarding the device based on the shape or location of the device which contacts the touch screen.

10. The interface apparatus as claimed in claim 9, wherein the first control command regarding the device includes at least one control command from among a command to display information regarding the device, a command to display contents stored in the device, a command to reproduce contents stored in the device, a command to transmit contents stored in the device, and a command to receive contents in the device.

11. The interface apparatus as claimed in claim 9, wherein the device includes a device having means for identifying the device,
wherein the control unit generates a control command regarding the device based on the information regarding the device extracted from the identifying means.

12. The interface apparatus as claimed in claim 1, wherein the touch includes multi-touch, in which a plurality of portions of the touch screen are touched, and
wherein the motion includes multi-motion regarding a plurality of objects.

13. An interface method using at least one of a touch screen and a motion sensor, the method comprising the steps of
sensing touch;
sensing motion in 3-dimensional space; and
generating at least one control command from among a first control command based on the touch, a second control command based on the motion, and a third control command based on interlocked manipulation of the touch and motion.

14. The interface method as claimed in claim 13, wherein the generating comprises;
extracting at least one piece of information from among the 2-dimensional coordinate information of the touch, the 3-dimensional coordinate information of the motion, the configuration information of the motion, and generating at least one control command from among the first to third control commands using the extracted information.

15. The interface method as claimed in claim 13, wherein the first to third control commands control at least one of the touch screen and the external apparatus.

16. The interface method as claimed in claim 15, further comprising transmitting at least one of the first to third control commands to at least one of the touch screen and the external apparatus based on at least one of the first to third control commands.

17. The interface method as claimed in claim 13, further comprising changing a screen displayed on the touch screen based on at least one of the generated first to third control commands.

18. The interface method as claimed in claim 13, wherein the third control command is a separate control command different from a combination of the first to second command.

19. The interface method as claimed in claim 13, wherein the touch screen or the 3-dimensional portion is divided into a plurality of portions, and the generating comprises generating a different control command depending on the portion of the screen on which touch, the motion, or the combination of the touch and motion is sensed.

20. The interface method as claimed in claim 19, wherein the plurality of portions include a first portion to control an external apparatus and a second portion to control the touch screen.

21. The interface method as claimed in claim 13, wherein the generating comprises generating a first control command regarding the device based on at least one of the shape and location of the device which contacts the touch screen.

22. The interface method as claimed in claim 21, wherein the first control command regarding the device includes at least one of a command to display information regarding the device, a command to reproduce contents stored in the device, a command to transmit contents stored in the device, and a command to receive contents in the device.

23. The interface method as claimed in claim 21, wherein the device includes a device having means for identifying the device,
wherein the generating comprises generating a first control command regarding the device based on information regarding the device extracted from the identifying means.

24. The interface method as claimed in claim 13, wherein the touch includes a multi-touch, in which a plurality of portions of the touch screen are touched, and the motion includes a multi-motion regarding a plurality of objects.

25. An interface system comprising;
an interface apparatus which generates a control command based on input touch or sensed 3-dimensional motion and transmits the control command to the outside; and
at least one interlocking apparatus which receives the control command and is operated based on the received control command.

26. The interface system as claimed in claim 25, wherein at least one of the interlocking apparatus includes at least one of the interface apparatus, image outputting apparatus, sound outputting apparatus, printing apparatus, and host apparatus.
